(19) United States
(12) Patent Application Publication
(10) Pub. No.: US 2016/0098442 A1
(43) Pub. Date: Apr. 7, 2016

(54) VERIFYING ANALYTICS RESULTS

(71) Applicant: Pivotal Software, Inc., Palo Alto, CA (US)

(72) Inventors: Lei Zhu, Beijing (CN); Ning Fu, Beijing (CN); Xiong Li, Beijing (CN); Yanhui Zhao, Beijing (CN); Xiaojian Wang, Beijing (CN)

(21) Appl. No.: 14/970,303

(22) Filed: Dec. 15, 2015

Related U.S. Application Data
(63) Continuation of application No. PCT/CN2014/076677, filed on Apr. 30, 2014.

(51) Int. Cl. G06F 17/30

(52) U.S. Cl. CPC G06F 17/30371

(57) ABSTRACT

Methods, systems, and apparatus, including computer programs encoded on computer storage media, for validating analytics results. One of the methods includes processing a subset of a dataset and polling an analytics system for a corresponding output subset and comparing the two subsets to validate the analytics system.

### BACKGROUND

This specification relates to cloud computing.

In cloud computing, data can be distributed to a system of multiple computers connected by one or more communications networks. Each computer can host one or more servers, each of which processes a portion of data. The servers can process the data in parallel. Such a distributed system can handle web-oriented and data-intensive applications deployed in a virtualized environment. Cloud computing systems can be used to perform big data analytics processes. Big data analytics processes can include examining large amounts of data of a variety of types to determine patterns, correlations, and other types of information. The data can be gathered from a variety of sources, e.g., web server logs, clickstream data, financial data, social media activity reports, and structured databases.

### SUMMARY

This specification describes a validation engine for an analytics system executing on a distributed computing system. The validation engine processes a subset of a dataset and polls the analytics system for a corresponding output subset and compares the two subsets to validate the analytics system. This is useful to validate an analytics system without having to validate an entire output set from the analytics system. For example, an organization that is beginning to use a new analytics system or is providing a new type of data to an analytics system can use the validation engine.

In general, one innovative aspect of the subject matter described in this specification can be embodied in methods that include the actions of receiving a request for validation of an analytics process configured to execute on a distributed computing system comprising a plurality of physical computers; receiving a raw subset of a dataset; processing the raw subset of the dataset to generate a first output subset, including executing a test script specifying an expression of the analytics process and supplying the raw subset as an input to the test script; receiving, from the distributed computing system that is executing the analytics process on the dataset, a second output subset that is a portion of an output of the analytics process executing on the distributed computing system, the second output subset resulting from the distributed computing system processing the raw subset; comparing the first output subset to the second output subset; and outputting, prior to the distributed computing system completing execution of the analytics process on the whole dataset, a validation result based on comparing the first output subset to the second output subset. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. The test script is written in the R programming language. Receiving the second output subset comprises polling the analytics system using an asynchronous callback function implemented using a RESTful API, the method comprising polling the analytics system in parallel with processing the raw subset. The first output subset comprises a first plurality of data elements and the second output subset comprises a second plurality of data elements, and wherein comparing the first output subset to the second output subset comprises comparing each data element in the first plurality of elements to a corresponding data element in the second plurality of data elements. The actions include determining a number of elements in the first plurality of elements that are about equal to a corresponding element in the second plurality of elements, wherein outputting the validation result comprises outputting a positive validation result if the number of elements is above or equal to a threshold and outputting a negative validation result if the number of elements is below the threshold. Receiving the raw subset comprises receiving the raw subset from a customer computer system, wherein the customer computer system provides the dataset to the analytics system and the analytics system provides the output to the customer computer system; and outputting the validation result comprises outputting the validation result to the customer computer system. The test script specifies a process for requesting, from the analytics system, the portion of the output of the analytics system resulting from the analytics system processing the raw subset. The process for requesting the portion of the output of the analytics system resulting from the analytics system processing the raw subset comprises an API call to the analytics system for requesting the second output subset by specifying data characterizing the raw subset

Particular embodiments of the subject matter described in this specification can be implemented to realize one or more advantages. A validation engine can output a validation result for an analytics system executing on a distributed computing system. The validation engine can produce the validation result in less time than it takes to validate an entire dataset. The validation engine can be used with various analytics systems, e.g., any analytics system that can provide a RESTful (REpresentational State Transfer) API (Application Programming Interface).

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTIONS OF DRAWINGS

FIG. 1 is a block diagram of an example computing system.

FIG. 2 is a block diagram of an example validation engine.

FIG. 3 is a flow chart of an example process performed by the validation engine of FIG. 2.

FIG. 4 is a flow chart of an example process performed by the comparator and threshold tester of FIG. 2.

Like reference numbers and designations in the various drawings indicate like elements.

### DETAILED DESCRIPTION

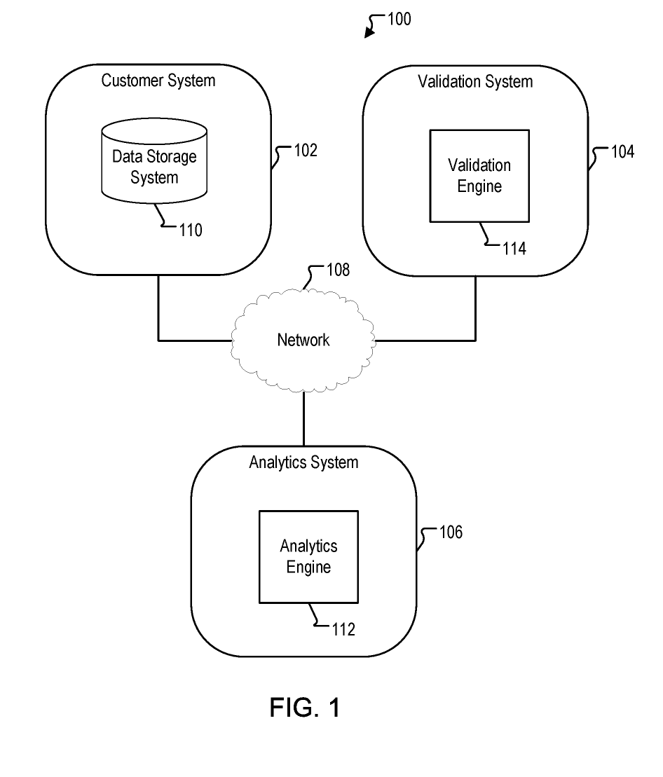

FIG. 1 is a block diagram of an example computing system 100. The system includes a customer system 102, a validation system 104, and an analytics system 106 connected by a data communications network 108. Each of the systems can include one or more computers connected by one or more communications networks. Each computer can be implemented as a physical computer or as software running on a virtual machine of a physical computer.

The customer system stores a dataset on a data storage system 110. The data storage system can be a distributed file system, which can include non-volatile mass storage memory, e.g., flash or disk memory. The dataset can be a file, a collection of files, a database, or a collection of data organized in any other fashion. The dataset can include various types of data collected from various sources. For example, the dataset can include web server logs, data reported by social networking systems, banking transactional data, healthcare data, sports statistics, and so on. The dataset can be stored in any appropriate data storage structure, e.g., a relational database or a dedicated XML store or the like.

The customer system uses the analytics system to perform an analytics process on the dataset using an analytics engine 112 executed by the analytics system. In some implementations, the customer system and the analytics system are both part of the same distributed computing system. The customer system transmits the dataset to the analytics system, e.g., by making the dataset available to the analytics system over the network so that the analytics system can request data as needed by the analytics process.

The analytics process can be any of various types of analytics processes, e.g., searching for patterns, determining correlations between subsets of the dataset, and calculating statistics characterizing the dataset. The analytics system typically performs the analytics process using a parallel, distributed process, e.g., by using MapReduce implemented using Apache Hadoop. The result of the analytics process is an analytics output, which can be, e.g., another dataset or one or more charts or other data visualizations or the like.

The customer system uses the validation system to validate the analytics process using a validation engine 114. The validation engine processes a subset of the dataset and polls the analytics engine for a corresponding output subset and compares the two subsets to validate the analytics engine. This is useful, e.g., to validate an analytics engine without having to validate an entire output set from the analytics engine, or to validate an analytics engine in less time than it takes the analytics engine to produce an entire output set.

The validation engine can receive the subset of the dataset from the customer system. The validation engine processes the subset using the same process as the analytics engine, or a process that produces the same result. For example, the validation engine may execute the process in a single computing system, eliminating the need for the overhead associated with the parallel, distributed process used by the analytics engine.

The validation engine receives the output subset from the analytics system. In some implementations, the validation engine polls the analytics system using an asynchronous callback function implemented using a RESTful API. The system can poll the analytics system in parallel with processing the subset of the dataset received from the customer system.

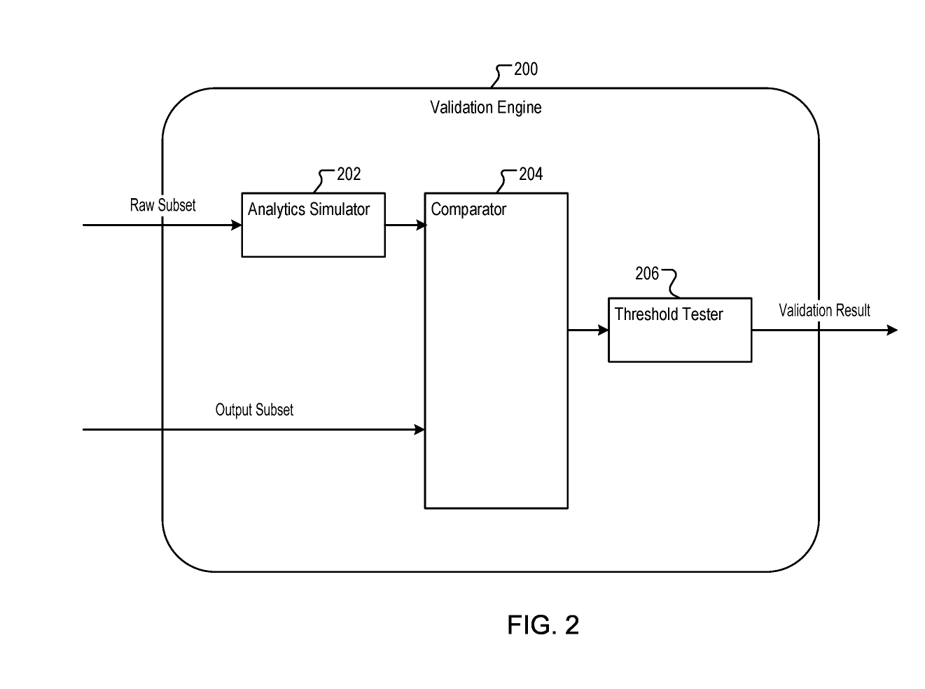

FIG. 2 is a block diagram of an example validation engine 200. The validation engine can be used in the validation system 104 of FIG. 1.

The validation engine receives a raw subset of a dataset from a customer system, e.g., the customer system 102 of FIG. 1. The raw subset is some portion of the dataset that has not been processed. The validation engine also receives an output subset from an analytics system, e.g., the analytics system 106 of FIG. 1. The output subset is a portion of an output of the analytics system, resulting from the analytics system processing the whole dataset according to an analytics process.

The output subset corresponds to the same portion of the dataset as the raw subset because the output subset is the result of the analytics system processing the raw subset. For example, if the raw subset is a number of columns from a table, then the output subset is the analytics output resulting from processing those columns using the analytics process.

In some implementations, the operation of the validation engine depends on an assumption that the contents of the output subset depend only on the raw subset and not on the entire dataset or some portion of the dataset that is greater than the raw subset. For example, if the analytics system is computing cumulative statistics, then the output subset may depend on the entire dataset, and the validation engine may not be able to validate the analytics system using solely the raw subset of the dataset.

In some implementations, the validation engine can update the raw subset if the analytics system makes any changes to the raw subset as part of performing the analytics process. For example, the validation engine can set a trigger with the analytics system when it receives the raw subset, so that the trigger causes the analytics system to supply an updated raw subset to the validation engine if the analytics system changes the raw subset. The validation engine can set the trigger using an API for the analytics system. In another example, the validation engine can periodically poll the analytics system to request any updates to the raw subset.

After receiving an updated raw subset from the analytics system, the validation engine can repeat the validation process using the updated raw subset to validate the analytics system. Although this may delay a final validation output from the validation engine, the validation process can still be useful to identify issues before the analytics system processes the entire dataset.

The validation engine includes an analytics simulator 202 that performs the analytics process using the raw subset. The analytics simulator can use a test script that specifies the analytics process. The analytics simulator can receive the test script from, e.g., a customer system or an analytics system. The test script can be a script written in the R programming language, in which case the analytics simulator can execute the test script using the raw subset as an input to the test script.

In some implementations, the test script also specifies which portion of the dataset the validation engine will use as the raw subset and how to request the corresponding output subset from the analytics system. For example, the test script can specify an API call to the analytics system for requesting the output subset by specifying data characterizing the raw subset. Pivotal Analytics service in Pivotal One provides some APIs which can enhance the functions of the R language.

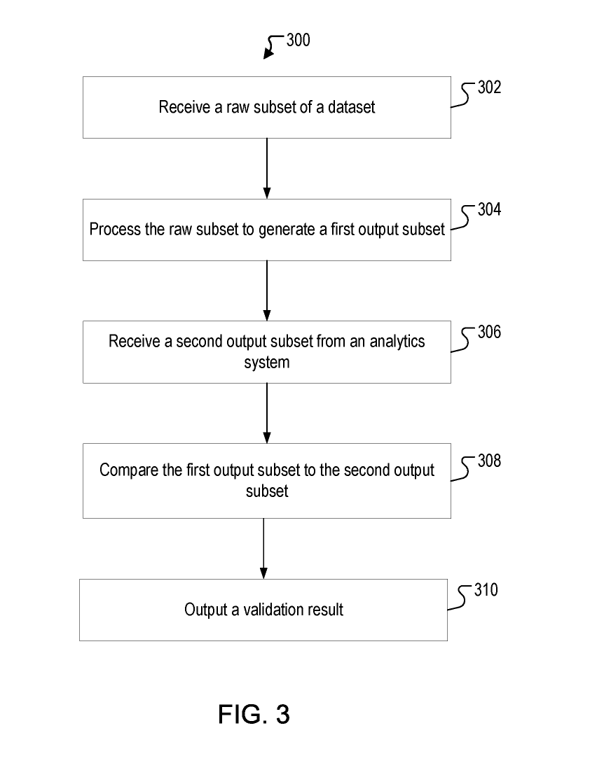

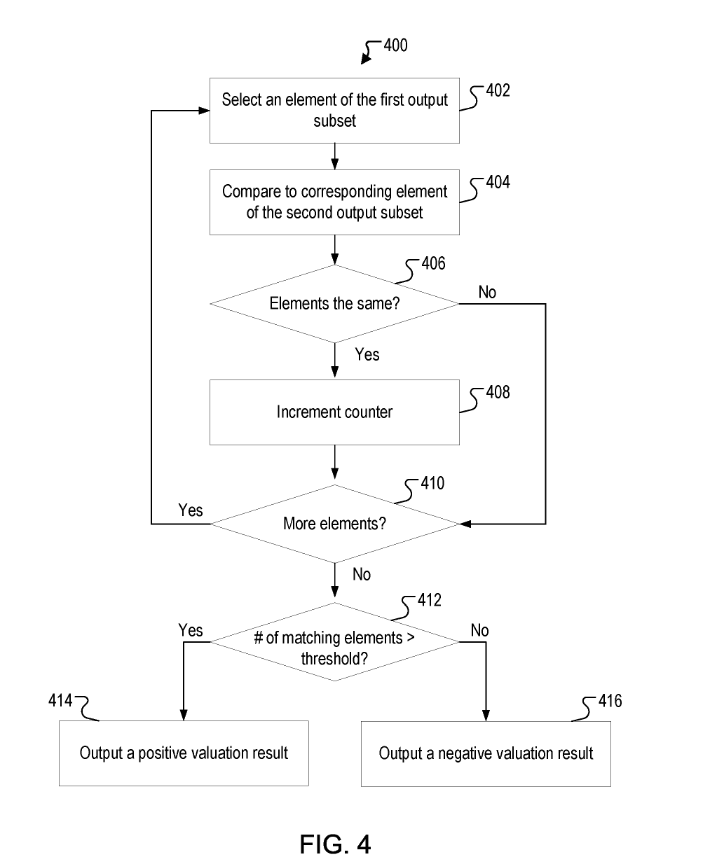

The validation engine includes a comparator 204 that compares the output subset from the analytics system with the output of the analytics simulator. For example, the comparator can examine individual data points within the subsets and determine whether they are equal or different by less than a threshold. In some cases, the output subset from the analytics system and the output of the analytics simulator may be in different data formats, e.g., one may be in a JSON format and the other may be in a CSV format, or one may be in a JSON format and the other may be in an XML, format. The comparator can convert one or both of the subsets into a common format, or the comparator can translate between the different formats on-the-fly while performing the comparison. Comparing data points is discussed further below with reference to FIGS. 3 and 4.

The validation engine includes a threshold tester 206 that determines whether the comparison of the output subset is sufficient to indicate a positive validation result. The threshold tester produces a validation result that is either positive or negative depending on the result of the comparison. For example, if the output subset differs from the output of the analytics simulator only in a number of data elements, and the number of data elements in less than a threshold, the threshold tester can output a positive validation result.

The customer system can use the validation result to validate the analytics system. If the validation result is negative, this can indicate that the analytics system may not be installed properly or executing properly, before the analytics system completes the analytics process on the entire data set, which may be a time consuming and costly operation.

FIG. 3 is a flow chart of an example process 300 performed by the validation engine 200 of FIG. 2. The validation engine receives a raw subset of a dataset (302). The validation engine processes the raw subset to generate a first output subset (304). The validation engine receives a second output subset from an analytics system that is processing the dataset (306). The second output subset corresponds in the dataset to the raw subset. The validation engine compares the first output subset to the second output subset (308). The validation engine outputs a validation result based on comparing the first output subset to the second output subset (310).

FIG. 4 is a flow chart of an example process 400 performed by the comparator 204 and threshold tester 206 of FIG. 2. The comparator selects an element of the first output subset (402). The comparator compares the selected element to the corresponding element of the second output subset (404). The corresponding element is, e.g., at the same row and column in a table, or nested to the same location in a hierarchical data structure. If the elements are the same (406) or different by only a threshold amount, then the comparator increments a counter (408). If there are more elements (410) the comparator repeats the process for the remaining elements or a certain number of elements.

The threshold tester determines the difference between the incremented counter and the total number of elements in each output subset. If the difference is greater than a threshold (412), the threshold tester outputs a positive validation result (414). Otherwise, the threshold tester outputs a negative validation result (416). This can be useful for very big data processes that cannot guarantee 100% accuracy of outputs.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, the subject matter is described in context of scientific papers. The subject matter can apply to other indexed work that adds depth aspect to a search. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method performed by one or more computers, the method comprising:
receiving a request for validation of an analytics process configured to execute on a distributed computing system comprising a plurality of physical computers;
receiving a raw subset of a dataset;
processing the raw subset of the dataset to generate a first output subset, including executing a test script specifying an expression of the analytics process and supplying the raw subset as an input to the test script;
receiving, from the distributed computing system that is executing the analytics process on the dataset, a second output subset that is a portion of an output of the analytics process executing on the distributed computing system, the second output subset resulting from the distributed computing system processing the raw subset;
comparing the first output subset to the second output subset; and
outputting, prior to the distributed computing system completing execution of the analytics process on the whole dataset, a validation result based on comparing the first output subset to the second output subset.

2. The method of claim 1, wherein the test script is written in the R programming language.

3. The method of claim 1, wherein receiving the second output subset comprises polling the analytics system using an asynchronous callback function implemented using a RESTful API, the method comprising polling the analytics system in parallel with processing the raw subset.

4. The method of claim 1, wherein the first output subset comprises a first plurality of data elements and the second output subset comprises a second plurality of data elements, and wherein comparing the first output subset to the second output subset comprises comparing each data element in the first plurality of elements to a corresponding data element in the second plurality of data elements.

5. The method of claim 4, comprising determining a number of elements in the first plurality of elements that are about equal to a corresponding element in the second plurality of elements, wherein outputting the validation result comprises outputting a positive validation result if the number of elements is above or equal to a threshold and outputting a negative validation result if the number of elements is below the threshold.

6. The method of claim 1, wherein:
receiving the raw subset comprises receiving the raw subset from a customer computer system, wherein the customer computer system provides the dataset to the analytics system and the analytics system provides the output to the customer computer system; and
outputting the validation result comprises outputting the validation result to the customer computer system.

7. The method of claim 1, wherein the test script specifies a process for requesting, from the analytics system, the portion of the output of the analytics system resulting from the analytics system processing the raw subset.

8. The method of claim 7, wherein the process for requesting the portion of the output of the analytics system resulting from the analytics system processing the raw subset comprises an API call to the analytics system for requesting the second output subset by specifying data characterizing the raw subset.

9. A system comprising one or more physical computers configured to perform operations comprising:
receiving a request for validation of an analytics process configured to execute on a distributed computing system comprising a plurality of physical computers;
receiving a raw subset of a dataset;
processing the raw subset of the dataset to generate a first output subset, including executing a test script specifying an expression of the analytics process and supplying the raw subset as an input to the test script;
receiving, from the distributed computing system that is executing the analytics process on the dataset, a second output subset that is a portion of an output of the analytics process executing on the distributed computing system, the second output subset resulting from the distributed computing system processing the raw subset;
comparing the first output subset to the second output subset; and
outputting, prior to the distributed computing system completing execution of the analytics process on the whole dataset, a validation result based on comparing the first output subset to the second output subset.

10. The system of claim 9, wherein the test script is written in the R programming language.

11. The system of claim 9, wherein receiving the second output subset comprises polling the analytics system using an asynchronous callback function implemented using a RESTful API, the method comprising polling the analytics system in parallel with processing the raw subset.

12. The system of claim 9, wherein the first output subset comprises a first plurality of data elements and the second output subset comprises a second plurality of data elements, and wherein comparing the first output subset to the second output subset comprises comparing each data element in the first plurality of elements to a corresponding data element in the second plurality of data elements.

13. The system of claim 12, the operations comprising determining a number of elements in the first plurality of elements that are about equal to a corresponding element in the second plurality of elements, wherein outputting the validation result comprises outputting a positive validation result if the number of elements is above or equal to a threshold and outputting a negative validation result if the number of elements is below the threshold.

14. The system of claim 9, wherein:
receiving the raw subset comprises receiving the raw subset from a customer computer system, wherein the customer computer system provides the dataset to the analytics system and the analytics system provides the output to the customer computer system; and
outputting the validation result comprises outputting the validation result to the customer computer system.

15. The system of claim 9, wherein the test script specifies a process for requesting, from the analytics system, the portion of the output of the analytics system resulting from the analytics system processing the raw subset.

16. The system of claim 15, wherein the process for requesting the portion of the output of the analytics system resulting from the analytics system processing the raw subset comprises an API call to the analytics system for requesting the second output subset by specifying data characterizing the raw subset.

17. A computer storage medium encoded with a computer program, the program comprising instructions that when executed by a distributed computing system of a plurality of physical computers causes the distributed computing system to perform operations comprising:
receiving a request for validation of an analytics process configured to execute on a distributed computing system comprising a plurality of physical computers;
receiving a raw subset of a dataset;
processing the raw subset of the dataset to generate a first output subset, including executing a test script specifying an expression of the analytics process and supplying the raw subset as an input to the test script;
receiving, from the distributed computing system that is executing the analytics process on the dataset, a second output subset that is a portion of an output of the analytics process executing on the distributed computing system, the second output subset resulting from the distributed computing system processing the raw subset;
comparing the first output subset to the second output subset; and
outputting, prior to the distributed computing system completing execution of the analytics process on the whole dataset, a validation result based on comparing the first output subset to the second output subset.

18. The computer storage medium of claim 17, wherein the test script is written in the R programming language.

19. The computer storage medium of claim 17, wherein receiving the second output subset comprises polling the analytics system using an asynchronous callback function implemented using a RESTful API, the method comprising polling the analytics system in parallel with processing the raw subset.

20. The computer storage medium of claim 17, wherein the first output subset comprises a first plurality of data elements and the second output subset comprises a second plurality of data elements, and wherein comparing the first output subset to the second output subset comprises comparing each data element in the first plurality of elements to a corresponding data element in the second plurality of data elements.

21. The computer storage medium of claim 20, the operations comprising determining a number of elements in the first plurality of elements that are about equal to a corresponding element in the second plurality of elements, wherein outputting the validation result comprises outputting a positive validation result if the number of elements is above or equal to a threshold and outputting a negative validation result if the number of elements is below the threshold.

22. The computer storage medium of claim 17, wherein:
receiving the raw subset comprises receiving the raw subset from a customer computer system, wherein the customer computer system provides the dataset to the analytics system and the analytics system provides the output to the customer computer system; and
outputting the validation result comprises outputting the validation result to the customer computer system.

23. The computer storage medium of claim 17, wherein the test script specifies a process for requesting, from the analytics system, the portion of the output of the analytics system resulting from the analytics system processing the raw subset.

24. The computer storage medium of claim 23, wherein the process for requesting the portion of the output of the analytics system resulting from the analytics system processing the raw subset comprises an API call to the analytics system for requesting the second output subset by specifying data characterizing the raw subset.
